(19) United States
(12) Patent Application Publication
(10) Pub. No.: US 2026/0291123 A1
(43) Pub. Date: Sep. 24, 2026

(54) SHIELDED ELECTRIC WIRE HOLDING STRUCTURE AND CONNECTOR

(71) Applicant: Yazaki Corporation, Tokyo (JP)

(72) Inventors: Masaaki IWABE, Shizuoka (JP); Masaki OTA, Shizuoka (JP); Yasuharu KONDO, Shizuoka (JP); Noriyuki MAKI, Shizuoka (JP); Naoki MORISHITA, Shizuoka (JP)

(73) Assignee: Yazaki Corporation, Tokyo (JP)

(21) Appl. No.: 19/561,653

(22) Filed: Mar. 10, 2026

(30) Foreign Application Priority Data
Mar. 19, 2025 (JP) 2025-044423

(51) Int. Cl. H01R 13/58

(52) U.S. Cl. CPC H01R 13/5812

(57) ABSTRACT

A shielded electric wire holding structure includes: a first housing part that is disposed in an upper shell attached to a housing into which front ends of shielded electric wires are drawn, and houses part of a shield terminal; a second housing part that is disposed in a lower shell attached to the upper shell, houses another part of the shield terminal, and is disposed to be capable of sandwiching the shield terminal with the first housing part; a first locking part (slit) and a first fixing part (through hole) disposed in the upper shell; and a second locking part (an arm part and a claw part) and a second fixing part (female screw part) disposed in the lower shell.

### CROSS-REFERENCE TO RELATED APPLICATIONS

The present application claims priority to and incorporates by reference the entire contents of Japanese Patent Application No. 2025-044423 filed in Japan on Mar. 19, 2025.

### BACKGROUND OF THE INVENTION

### 1. Field of the Invention

The present invention relates to a shielded electric wire holding structure and a connector.

### 2. Description of the Related Art

As a technique relating to a conventional shielded electric wire holding structure and connector, for example, JP 7 381 540 B2 discloses a connector including a housing from which a pair of electric wires extend to be inserted through electric wire insertion holes, and in which a pressing plate is fastened and fixed to the housing together with a cover that covers an opening part of the housing by means of a plurality of screws. The pressing plate is a member made of metal, includes a flange having a bolt insertion hole, and is fixed to a counterpart component by using the bolt insertion hole.

For such a connector, for example, it is necessary to prepare a plurality of screws for fixing the pressing plate to the housing, and an operation of fastening each screw takes time. In a case where an electric wire drawn into the housing is a shielded electric wire, the shielded electric wire may be held by a member to be attached to the housing, such as the pressing plate, but there is room for further improvement in a configuration for holding the shielded electric wire.

### SUMMARY OF THE INVENTION

The present invention has been made in view of the circumstances described above, and aims to provide a shielded electric wire holding structure and a connector that can properly implement a configuration for holding a shielded electric wire.

In order to achieve the above mentioned object, a shielded electric wire holding structure according to one aspect of the present invention includes a first housing part that is disposed in an upper shell attached to a housing, into which a front end of a shielded electric wire including a shield material and a shield terminal electrically connected to the shield material is drawn, and houses part of the shield terminal; a second housing part that is disposed in a lower shell attached to the upper shell, houses another part of the shield terminal, and is disposed to be opposed to the first housing part so as to be capable of sandwiching the shield terminal with the first housing part; a first locking part and a first fixing part that are disposed in the upper shell to sandwich the first housing part along an arranging direction intersecting an extending direction of the shielded electric wire; and a second locking part and a second fixing part that are disposed in the lower shell to sandwich the second housing part along the arranging direction, wherein the second locking part is locked to the first locking part, the first fixing part includes one of a female screw part into which a bolt is screwed and a through hole into which the bolt is inserted, and the second fixing part includes the other one of the female screw part into which the bolt is screwed and the through hole into which the bolt is inserted.

In order to achieve the above mentioned object, a connector according to another aspect of the present invention includes a housing into which a front end of a shielded electric wire including a shield material and a shield terminal electrically connected to the shield material is drawn; an upper shell that is attached to the housing and includes a first housing part that houses part of the shield terminal; and a lower shell that is attached to the upper shell and includes a second housing part that houses another part of the shield terminal and is disposed to be opposed to the first housing part so as to be capable of sandwiching the shield terminal with the first housing part, wherein the upper shell includes a first locking part and a first fixing part that are disposed to sandwich the first housing part along an arranging direction intersecting an extending direction of the shielded electric wire, the lower shell includes a second locking part and a second fixing part that are disposed to sandwich the second housing part along the arranging direction, the second locking part is locked to the first locking part, the first fixing part includes one of a female screw part into which a bolt is screwed and a through hole into which the bolt is inserted, and the second fixing part includes the other one of the female screw part into which the bolt is screwed and the through hole into which the bolt is inserted.

### BRIEF DESCRIPTION OF THE DRAWINGS

FIG. 1 is a perspective view illustrating a connector according to an embodiment;

FIG. 2 is an exploded perspective view illustrating the connector according to the embodiment;

FIG. 3 is an exploded perspective view illustrating a part around electric wire insertion parts and shielded electric wires in a housing according to the embodiment;

FIG. 4 is a bottom view illustrating a part around a first housing part of an upper shell according to the embodiment;

FIG. 5 is a perspective view illustrating a lower shell according to the embodiment;

FIG. 6 is a partially enlarged cross-sectional view of a VI-VI cross section in FIG. 1, where the shielded electric wire is not shown as a cross section;

FIG. 7 is a VII-VII cross-sectional view of FIG. 1;

FIG. 8 is an enlarged cross-sectional view of a part P in FIG. 7;

FIG. 9 is a perspective view illustrating a part around a shielded electric wire holding structure according to the embodiment;

FIG. 10 is a bottom view illustrating a part around the shielded electric wire holding structure according to the embodiment;

FIG. 11 is a perspective view of the connector according to the embodiment for explaining a state in which the lower shell is assembled to the upper shell; and

FIG. 12 is a front view of the connector according to the embodiment for explaining a state in which the lower shell is assembled to the upper shell.

### DETAILED DESCRIPTION OF THE PREFERRED EMBODIMENTS

The following describes an embodiment according to the present invention in detail based on the drawings. The invention is not limited to the embodiment. Constituent elements in the embodiment described below encompass a constituent element that can be easily replaced by those skilled in the art or a constituent element that is substantially the same.

### Embodiment

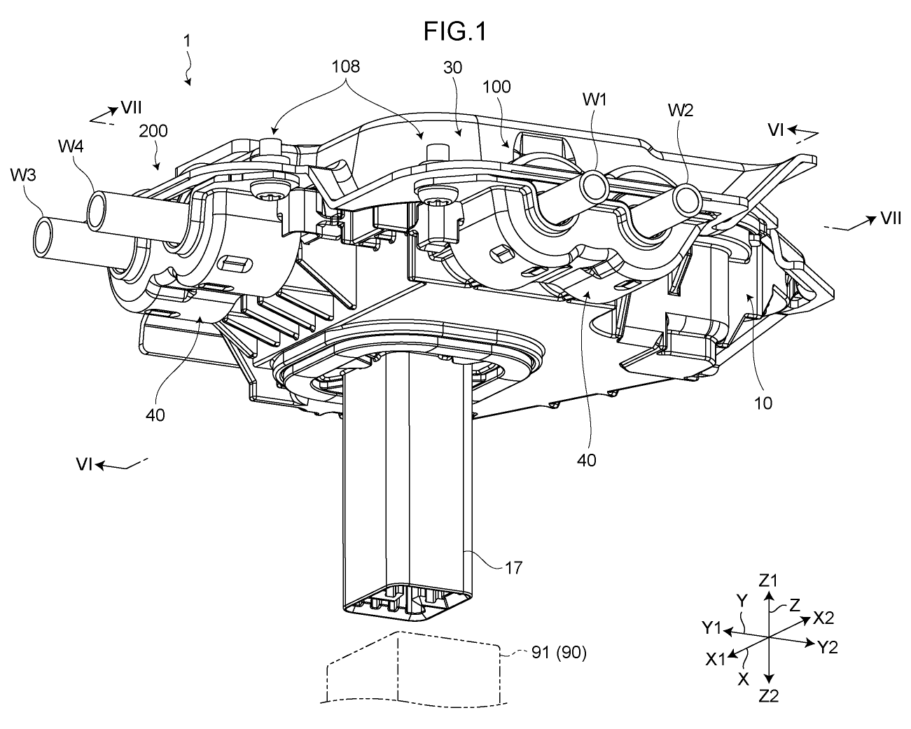

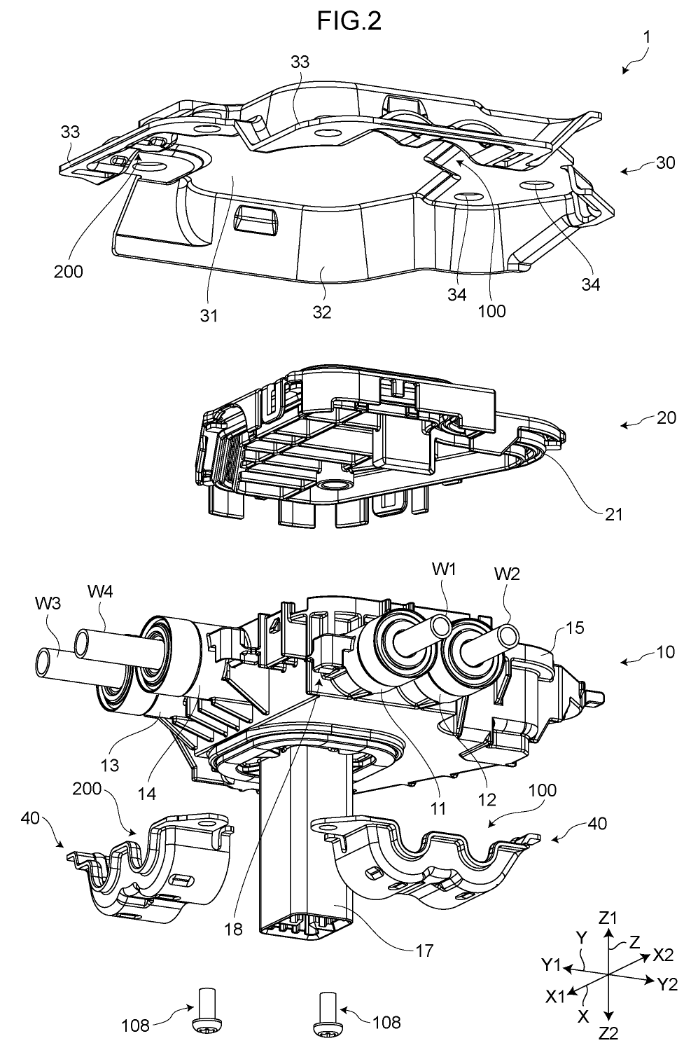

A connector 1 of the present embodiment illustrated in FIG. 1 and FIG. 2 includes a tubular part 17 having a square cylindrical shape, and fits with a tubular part 91 of a counterpart connector 90. Herein, the connector 1 is a male connector into which front ends of a plurality of shielded electric wires W1, W2, W3, and W4 are drawn, having the tubular part 17 as a connection part. The counterpart connector 90 is a female connector having the tubular part 91 as a connection part. The connector 1 is, for example, incorporated into a wire harness that is routed in a vehicle such as an automobile. Herein, the wire harness is, for example, a collective component obtained by bundling wiring materials used for power supply and signal communication for connection between respective devices mounted on a vehicle, and in which the wiring materials are connected to the respective devices by the connector 1 and the like. The wire harness includes, for example, the shielded electric wires W1, W2, W3, and W4, the connector 1 into which the front ends of the shielded electric wires W1, W2, W3, and W4 are drawn, and the counterpart connector 90 that is electrically and mechanically connected to the connector 1. The wire harness may further include various constituent parts such as a grommet, a protector, or a fixture.

As illustrated in FIG. 2, the connector 1 includes a housing 10, a rear cover 20, an upper shell 30, and a lower shell 40. A pair of the two shielded electric wires W3 and W4 are drawn into the housing 10 from a direction orthogonal to an extending direction of a pair of the two shielded electric wires W1 and W2. As illustrated in FIG. 1 and FIG. 2, the pair of two shielded electric wires W1 and W2 are held by a shielded electric wire holding structure 100. The pair of two shielded electric wires W3 and W4 are held by a shielded electric wire holding structure 200. The shielded electric wire holding structures 100 and 200 have similar configurations. Thus, the following describes the shielded electric wire holding structure 100 in detail, and the configuration of the shielded electric wire holding structure 200 will not be described in detail.

In the following description, a direction in which the shielded electric wires W1 and W2 extend is assumed to be an extending direction X, a direction orthogonal to the extending direction X and in which the shielded electric wires W3 and W4 are arranged is assumed to be an arranging direction Y, and a direction orthogonal to both the extending direction X and the arranging direction Y is assumed to be a height direction Z. In the following description, one side in the extending direction X is described as one side X1, and the other side is described as the other side X2. Similarly, one side Y1 and the other side Y2 are defined for the arranging direction Y, and one side Z1 and the other side Z2 are defined for the height direction Z.

The housing 10 is formed of a resin material having an insulating property. As illustrated in FIG. 2, the housing 10 includes a housing main body 15 and the tubular part 17 having a square cylindrical shape, the tubular part 17 extending from a surface on the other side Z2 in the height direction Z of the housing main body 15 toward the other side Z2. A plurality of male terminals are disposed inside the tubular part 17 of the housing 10. The housing main body 15 is formed in a substantially rectangular box shape in which a length in the height direction Z is smaller than lengths in the extending direction X and the arranging direction Y. Although not illustrated in the drawing, the one side Z1 in the height direction Z of the housing main body 15 is open. In the housing main body 15, electric wire insertion parts 11 and 12, into which the front ends of the shielded electric wires W1 and W2 are inserted, are disposed on a side surface on the other side X2 in the extending direction X. Each of the electric wire insertion parts 11 and 12 is formed in a substantially cylindrical shape. On a side surface on the one side Y1 in the arranging direction Y of the housing main body 15, electric wire insertion parts 13 and 14, into which the front ends of the shielded electric wires W3 and W4 are inserted, are disposed.

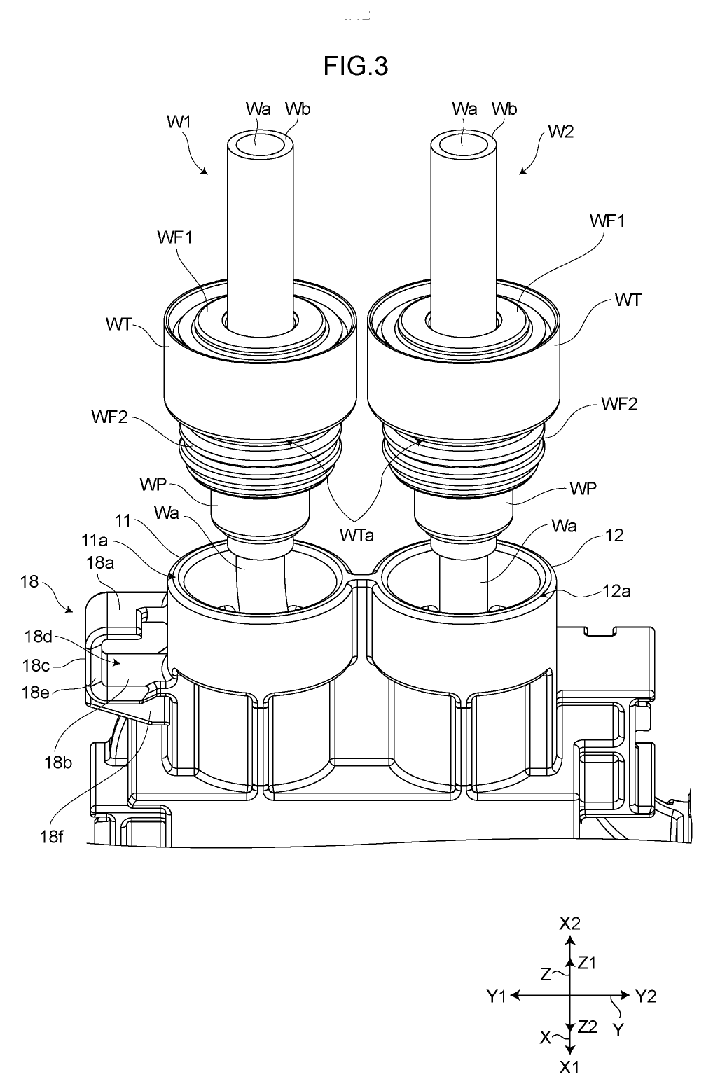

As illustrated in FIG. 3, among the electric wire insertion parts 11 and 12, on an outer peripheral surface on the one side Y1 of the electric wire insertion part 11 that is arranged on the one side Y1 in the arranging direction Y, a rotation regulating wall part 18 is disposed to project toward the one side Y1. The rotation regulating wall part 18 includes a first rotation regulating wall part 18a that is disposed on the other side X2 with its plate surface directed toward the extending direction X, a second rotation regulating wall part 18b that is disposed on the one side X1 with its plate surface directed toward the extending direction X and is opposed to the first rotation regulating wall part 18a in the extending direction X, and a connection wall 18c that is disposed with its plate surface directed toward the arranging direction Y to connect the first rotation regulating wall part 18a and the second rotation regulating wall part 18b. In other words, the first rotation regulating wall part 18a of the rotation regulating wall part 18 and the second rotation regulating wall part 18b of the rotation regulating wall part 18 are disposed on the extending direction X side of a rotation regulating projecting part 48. A portion surrounded by the first rotation regulating wall part 18a, the second rotation regulating wall part 18b, and the connection wall 18c is defined as an opening 18d that extends through in the height direction Z. Each tip end on the other side Z2 in the height direction Z of the first rotation regulating wall part 18a, the second rotation regulating wall part 18b, and the connection wall 18c is provided with a tapered surface 18e that is inclined such that a cross-sectional area of the opening 18d (a cross-sectional area in a plane including the extending direction X and the arranging direction Y) gradually decreases from the other side Z2 toward the one side Z1 in the height direction Z. Additionally, on the one side X1 in the extending direction X of the second rotation regulating wall part 18b, a reinforcing rib 18f is disposed to be connected to an outer periphery of the electric wire insertion part 11 with its plate surface directed toward the height direction Z.

Herein, the shielded electric wires W1 and W2 each include a core wire part Wa including a core wire, and a sheath Wb having an insulating property and disposed on an outer periphery of the core wire part Wa. The core wire part Wa is formed to have a circular cross section, and is formed of, for example, a core wire that is formed by twisting and bundling a linear conductor made of metal or a plurality of linear conductors made of metal, and a resin layer having an insulating property or an inner sheath disposed on an outer periphery of the core wire. A shield material (not illustrated) is disposed between the core wire part Wa and the sheath Wb. The shield material suppresses entry of noise into the core wire of the core wire part Wa, and may be, for example, a braided body in which a linear conductor made of metal is braided in a mesh shape and in a cylindrical shape, or may be a foil material made of metal (what is called metal foil) formed in a cylindrical shape.

The shielded electric wires W1 and W2 are provided with shield terminals WT, respectively. The shield terminals WT are made of metal, each formed in a cylindrical shape, and electrically connected to shield materials included in the shielded electric wires W1 and W2. Inside the shield terminal WT, a gasket WF1 is disposed to seal between an inner periphery of the shield terminal WT and an outer periphery of each of the shielded electric wires W1 and W2, and to hold the shield terminal WT with respect to each of the shielded electric wires W1 and W2. On the one side X1 in the extending direction X of the shield terminal WT, a gasket WF2 is disposed to seal an interior of each of the electric wire insertion parts 11 and 12, and a shield pipe WP made of metal is disposed to electrically connect the shield material of each of the shielded electric wires W1 and W2 to the shield terminal WT.

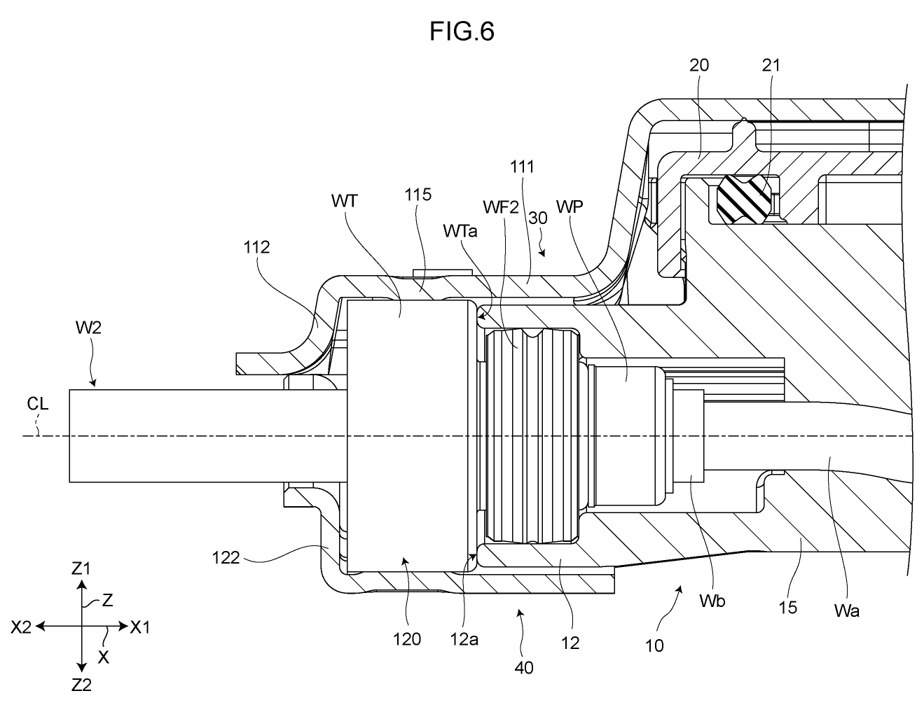

With reference to FIG. 3 and FIG. 6, in each of the shielded electric wires W1 and W2, the core wire part Wa is exposed on the one side X1 in the extending direction X of the shield pipe WP, and the shielded electric wires W1 and W2 are inserted and drawn into an interior of the housing main body 15 through the electric wire insertion parts 11 and 12. The core wire parts Wa of the respective shielded electric wires W1 and W2, which are inserted and drawn into the interior of the housing main body 15, are connected to a plurality of male terminals disposed in the tubular part 17 via connection terminals or the like (not illustrated). Shield pipes WP and gaskets WF2 of the respective shielded electric wires W1 and W2 are housed inside the electric wire insertion parts 11 and 12. Outer peripheral surfaces of the gaskets WF2 are in close contact with respective inner peripheral surfaces of the electric wire insertion parts 11 and 12. Herein, an outer diameter of the shield terminal WT is formed to be larger than an outer diameter of each of the electric wire insertion parts 11 and 12. The shield terminal WT is formed in a substantially bottomed cylindrical shape, and a flange surface is disposed on the one side X1 in the extending direction X of the shield terminal WT. Thus, surfaces WTa on the one side X1 in the extending direction X of the shield terminals WT abut on end parts 11a and 12a on the other side X2 of the electric wire insertion parts 11 and 12.

As illustrated in FIG. 2, an opening (not illustrated) on the one side Z1 in the height direction Z of the housing main body 15 of the housing 10 is covered by the rear cover 20 attached to the housing main body 15. The rear cover 20 is formed in a substantially flat plate shape by a resin material having an insulating property. Between the rear cover 20 and the housing main body 15, a gasket 21 is disposed along an edge of the opening of the housing 10 (refer to FIG. 6), and a space between an opening edge of the opening of the housing main body 15 and the rear cover 20 is sealed.

The shielded electric wire holding structure 100 that holds the shielded electric wires W1 and W2 includes a first housing part 110, a first locking part 116, and a first fixing part 117 disposed on a holding plate 33 of the upper shell 30, and a second housing part 120, a second locking part 126, and a second fixing part 127 disposed on the lower shell 40. The following describes the upper shell 30 and the lower shell 40 in detail.

As illustrated in FIG. 2, the upper shell 30 is formed in a substantially shell shape by a metal material having electrical conductivity. Specifically, a top plate 31 having a plate surface directed toward the height direction Z, and a peripheral wall 32 that extends from the top plate 31 toward the other side Z2 in the height direction Z and has a plate surface directed in a direction parallel to the arranging direction Y, are disposed thereon. The peripheral wall 32 is disposed around the top plate 31 in a partially intermittent manner. On the peripheral wall 32 of the upper shell 30 corresponding to the electric wire insertion parts 11 and 12 and the electric wire insertion parts 13 and 14 of the housing 10, the holding plate 33 having a plate surface directed toward the height direction Z is disposed. The upper shell 30 formed in this manner is attached to the housing main body 15 of the housing 10 to cover the rear cover 20. The upper shell 30 is attached to the housing main body 15 by being fixed with a plurality of bolts inserted through a plurality of bolt through holes 34 disposed in the upper shell 30 via bolt through holes (not illustrated) of the housing 10 disposed corresponding to the bolt through holes 34, and with nuts (not illustrated) to be screwed onto the bolts.

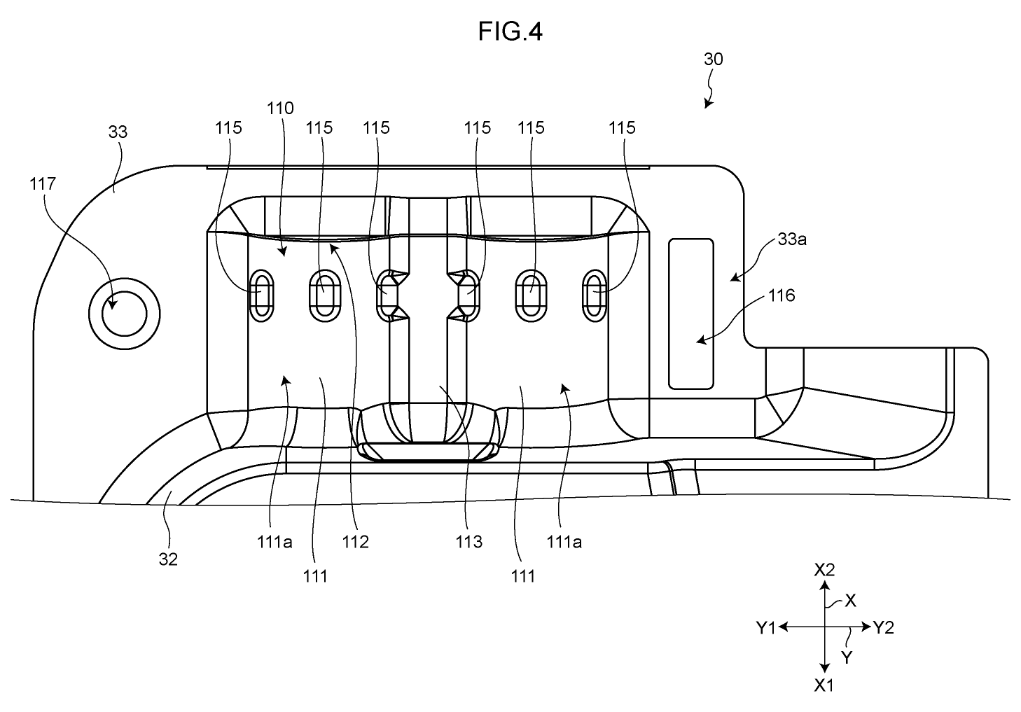

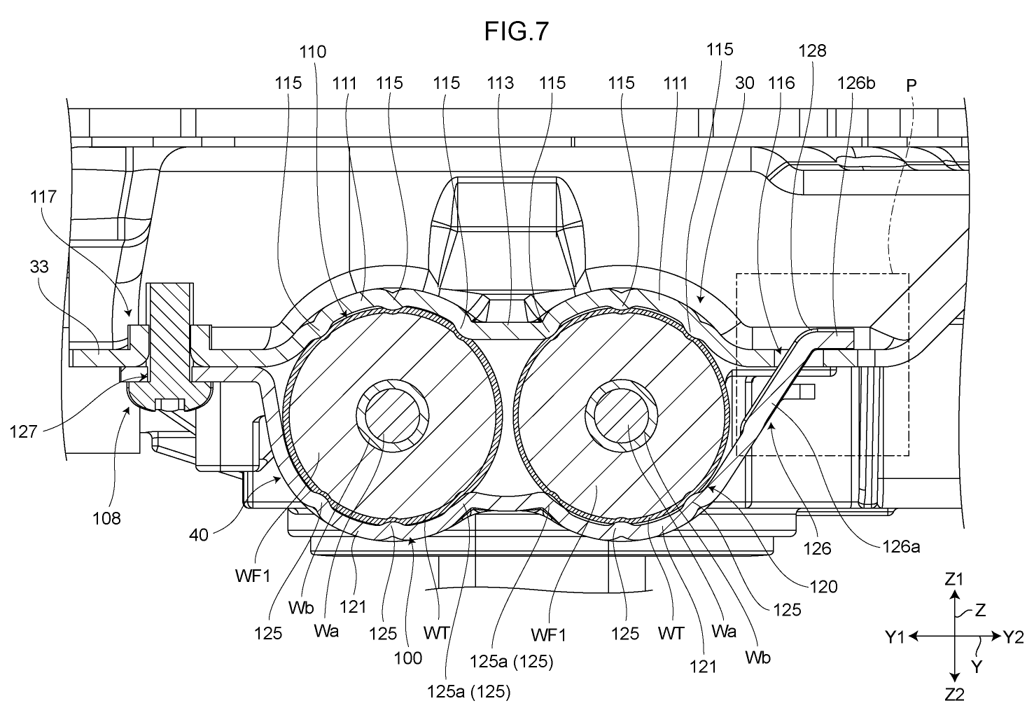

As illustrated in FIG. 4, the first housing part 110 is disposed on the holding plate 33 of the upper shell 30 corresponding to the electric wire insertion parts 11 and 12. The first housing part 110 includes two semicylindrical peripheral wall parts 111, a vertical plate 112, and a connection plate 113. The semicylindrical peripheral wall parts 111 of the first housing part 110 are each formed in a recessed shape from a surface on the other side Z2 in the height direction Z of the holding plate 33, and are each formed in a substantially semicylindrical shape with an axis (in other words, an axis CL of each of the shielded electric wires W1 and W2; refer to FIG. 6) directed toward the extending direction X. The one side X1 in the extending direction X of the semicylindrical peripheral wall part 111 is open. On the other side X2 in the extending direction X of the semicylindrical peripheral wall part 111, the vertical plate 112 having a plate surface directed toward the extending direction X is disposed. The vertical plate 112 is formed to extend from the semicylindrical peripheral wall part 111 on the one side Y1 in the arranging direction Y to the semicylindrical peripheral wall part 111 on the other side Y2 via the connection plate 113 described later, while following a substantially semicylindrical shape of each of the semicylindrical peripheral wall parts 111 and the connection plate 113. The connection plate 113 is disposed between the two semicylindrical peripheral wall parts 111. The connection plate 113 is formed in a flat plate shape having a plate surface directed toward the height direction Z, and is disposed to connect adjacent end parts of the two semicylindrical peripheral wall parts 111 that are each formed in a substantially semicylindrical shape (refer to FIG. 7).

The semicylindrical peripheral wall part 111 on the one side Y1 in the arranging direction Y corresponds to the electric wire insertion part 11, and the semicylindrical peripheral wall part 111 on the other side Y2 corresponds to the electric wire insertion part 12. Each of the semicylindrical peripheral wall parts 111 of the first housing part 110 houses part of the shield terminal WT of each of the shielded electric wires W1 and W2, and specifically houses substantially 1/3 of the shield terminal WT on the one side Z1 in the height direction Z (refer to FIG. 6 and FIG. 7).

As illustrated in FIG. 4, on peripheral surfaces 111a, which are inner surfaces (on a side of the shield terminal WT to be housed) of the semicylindrical peripheral wall parts 111 in the first housing part 110, a plurality of first protruding parts 115 that protrude toward the second housing part 120 described later and abut on the shield terminal WT are disposed. The first protruding parts 115 are disposed in three pieces at substantially regular intervals around an axis (in other words, the axis CL of each of the shielded electric wires W1 and W2; refer to FIG. 6) of each of the semicylindrical peripheral wall parts 111 having a substantially semicylindrical shape in the first housing part 110, for a total of six pieces. The first protruding part 115 is formed as a protruding part having a rounded-corner long rectangular shape that is long in the extending direction X. Among the three first protruding parts 115 in each of the semicylindrical peripheral wall parts 111 of the first housing part 110, one of the first protruding parts 115 is disposed at a connecting portion between the semicylindrical peripheral wall part 111 and the connection plate 113.

As illustrated in FIG. 4, on the holding plate 33 of the upper shell 30, the first locking part 116 and the first fixing part 117 are disposed to sandwich the first housing part 110 along the arranging direction Y. The first locking part 116 is locked to the second locking part 126 described later. The first locking part 116 is disposed on the holding plate 33 on the other side Y2 of the first housing part 110. Specifically, the first locking part 116 is formed as a slit that extends through in the height direction Z and is long in the extending direction X. The first fixing part 117 is disposed on the holding plate 33 on the one side Y1 of the first housing part 110. The first fixing part 117 is a female screw part into which a bolt 108 (refer to FIG. 2) is screwed.

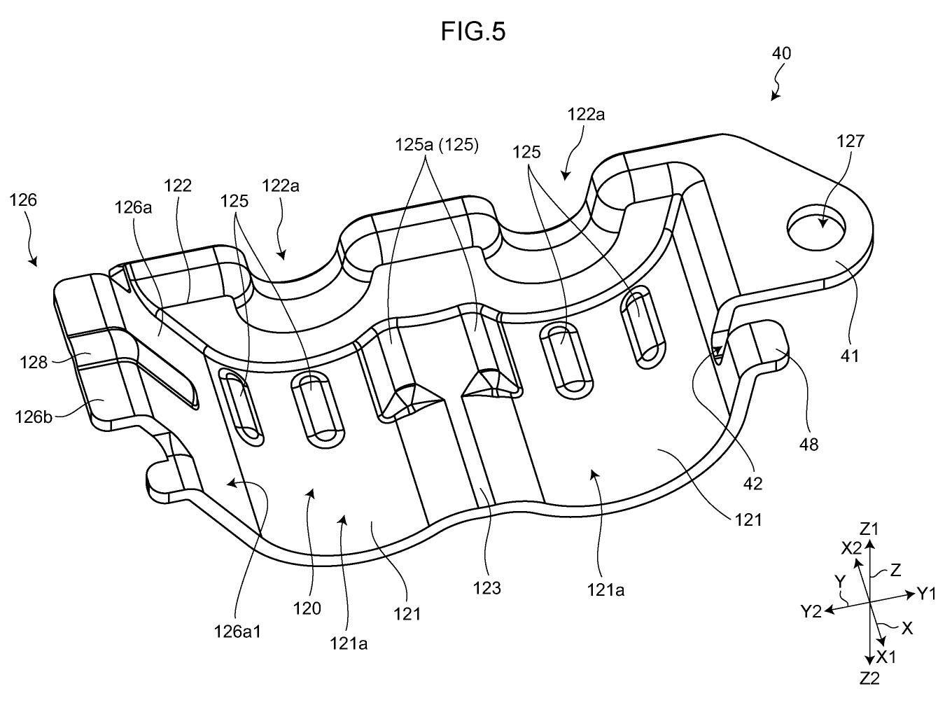

As illustrated in FIG. 5, the lower shell 40 is formed in a substantially shell shape by a metal material having electrical conductivity. The lower shell 40 includes the second housing part 120. The second housing part 120 includes two semicylindrical peripheral wall parts 121, a vertical plate 122, and a connection part 123. Each of the semicylindrical peripheral wall parts 121 is formed in a substantially semicylindrical shape with its axis directed toward the extending direction X. The one side X1 in the extending direction X of the semicylindrical peripheral wall part 121 is open. On the other side X2 in the extending direction X of the semicylindrical peripheral wall part 121, the vertical plate 122 having a plate surface directed toward the extending direction X is disposed. The vertical plate 122 is formed to extend from the semicylindrical peripheral wall part 121 on the one side Y1 in the arranging direction Y to the semicylindrical peripheral wall part 121 on the other side Y2 via the connection part 123, while following a substantially semicylindrical shape of each of the semicylindrical peripheral wall parts 121 and the connection part 123. In the vertical plate 122, two notch parts 122a each having a substantially concave arc shape are disposed corresponding to the shielded electric wires W1 and W2 to avoid interference with the shielded electric wires W1 and W2. In the second housing part 120, the connection part 123 that connects end parts of the adjacent semicylindrical peripheral wall parts 121 is disposed. Each of the semicylindrical peripheral wall parts 121 of the second housing part 120 houses another part of the shield terminal WT of each of the shielded electric wires W1 and W2, and specifically houses substantially 2/3 of the shield terminal WT on the other side Z2 in the height direction Z (refer to FIG. 6 and FIG. 7). The semicylindrical peripheral wall part 121 on the one side Y1 in the arranging direction Y corresponds to the electric wire insertion part 11, and the semicylindrical peripheral wall part 121 on the other side Y2 corresponds to the electric wire insertion part 12.

On peripheral surfaces 121a, which are inner surfaces (on a side of the shield terminal WT to be housed) of the semicylindrical peripheral wall parts 121 in the second housing part 120, a plurality of second protruding parts 125 that protrude toward the first housing part 110 and abut on the shield terminal WT are disposed. The second protruding parts 125 are disposed in three pieces at substantially regular intervals around an axis (in other words, the axis CL of each of the shielded electric wires W1 and W2; refer to FIG. 6) of each of the semicylindrical peripheral wall parts 121, for a total of six pieces. Among the three second protruding parts 125 in each of the semicylindrical peripheral wall parts 121 of the second housing part 120, one of the second protruding parts 125 is disposed as a second protruding part 125a at a connecting portion between the semicylindrical peripheral wall part 121 and the connection part 123. The second protruding part 125a is formed in a substantially mountain shape that is long in the extending direction X, and the other second protruding parts 125 are formed as protrusions having a rounded-corner long rectangular shape that is long in the extending direction X.

On the lower shell 40, the second locking part 126 and the second fixing part 127 are disposed to sandwich the second housing part 120 along the arranging direction Y. The second locking part 126 is locked to the first locking part 116. The second locking part 126 includes an arm part 126a having a plate shape that extends from the semicylindrical peripheral wall part 121 of the second housing part 120 on the other side Y2 in the arranging direction Y toward the one side Z1 in the height direction Z and the other side Y2 in the arranging direction Y. The second locking part 126 also includes a claw part 126b that is formed by being bent from the arm part 126a toward the other side Z2 in the height direction Z. The claw part 126b is formed in a substantially flat plate shape having a plate surface directed toward the height direction Z. The arm part 126a and the claw part 126b are formed to be insertable into the first locking part 116, which is a slit disposed in the upper shell 30. Specifically, as illustrated in FIG. 7 to FIG. 9, a length along the extending direction X of the first locking part 116 (that is, a length in a longitudinal direction of the first locking part 116 as a slit) is formed to be longer than a length along the extending direction X of the arm part 126a and a length along the extending direction X of the claw part 126b (that is, a width of the second locking part 126). A length in the arranging direction Y of the first locking part 116 is longer than a plate thickness of the second locking part 126 (the arm part 126a, the claw part 126b).

Returning to FIG. 5, the second locking part 126 includes a ridge part 128. The ridge part 128 is formed to continuously project from a tip end of the claw part 126b to a surface 126a1 on a side of the first housing part 110 of the arm part 126a. The ridge part 128 is located at a substantially center position along the extending direction X of the claw part 126b and the arm part 126a. The ridge part 128 is inserted through the slit (first locking part 116) together with the arm part 126a and the claw part 126b (refer to FIG. 7 to FIG. 9).

The second fixing part 127 is disposed on the one side Y1 in the arranging direction Y of the second housing part 120. More specifically, the second fixing part 127 is disposed as a bolt through hole, which is a through hole, in a fixing plate 41 that is connected to the semicylindrical peripheral wall part 121 on the one side Y1 in the arranging direction Y and the vertical plate 122 and has a plate surface directed toward the height direction Z. In the lower shell 40, the rotation regulating projecting part 48 is disposed on the one side X1 in the extending direction X of the fixing plate 41 via a notch 42. The rotation regulating projecting part 48 is formed to project toward the one side Y1 in the arranging direction Y, in such a manner that, on a side of the second fixing part 127, a vicinity of an end part of the semicylindrical peripheral wall part 121 of the second housing part 120 on the one side Y1 is formed in a tongue shape by the notch 42, and a front end of this tongue-shaped portion is subjected to a bending process.

As illustrated in FIG. 7, the lower shell 40 is attached to the upper shell 30. At this time, the second locking part 126 is locked to the first locking part 116. The bolt 108 is inserted into the second fixing part 127, which is a through hole, from the other side Z2 in the height direction Z, and is screwed into the first fixing part 117, which is a female screw part. In this manner, the lower shell 40 is fixed to the upper shell 30.

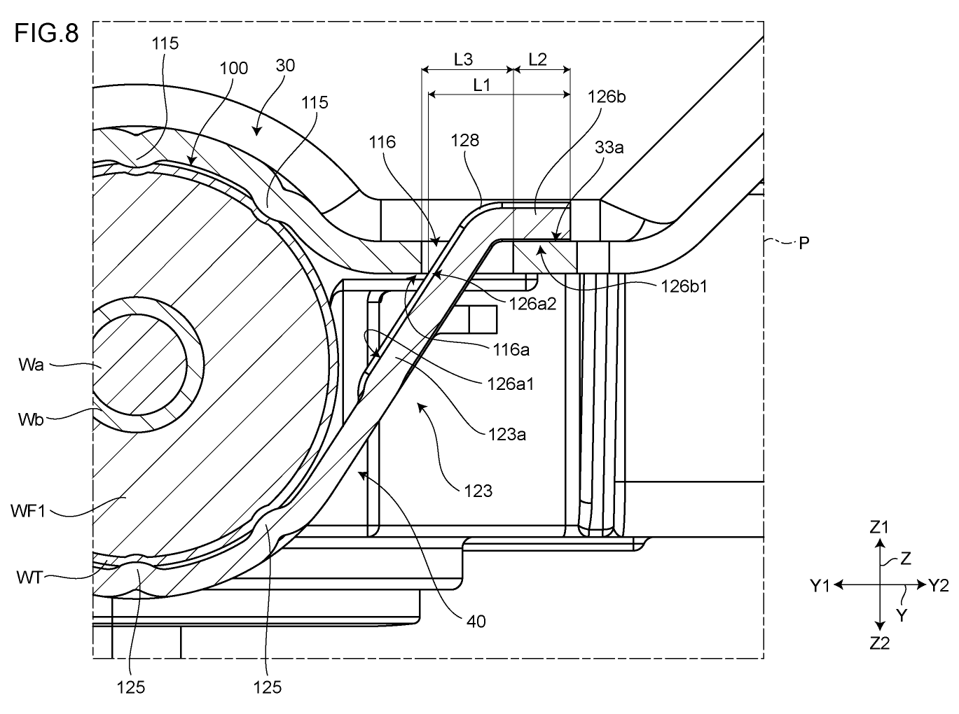

The following describes locking between the first locking part 116 and the second locking part 126 in more detail. As illustrated in FIG. 8, the claw part 126b inserted into the slit (first locking part 116) includes an abutting part 126b1 that abuts on an outer edge part 33a on an outer side (the other side Y2 in the arranging direction Y) of the slit (first locking part 116). The outer edge part 33a and the abutting part 126b1 are both formed in a flat surface shape. The outer edge part 33a is located on a side opposite to the first housing part 110 with respect to the slit (first locking part 116) in the arranging direction Y (refer to FIG. 4).

As illustrated in FIG. 8, a length L3 along the arranging direction Y of the slit (first locking part 116) is longer than a length L2 along the arranging direction Y of the abutting part 126b1 (L3 > L2), and is shorter than a length L1 along the arranging direction Y from an interference part 126a2, which is a portion of the surface 126a1 on a side of the first housing part 110 of the arm part 126a and is closest to an opening edge 116a of the slit (first locking part 116), to a tip end of the abutting part 126b1 (L3 < L1).

As illustrated in FIG. 7, the respective shield terminals WT of the shielded electric wires W1 and W2 are held to be sandwiched by the first housing part 110 of the upper shell 30 and the second housing part 120 of the lower shell 40 that are disposed to be opposed to each other along the height direction Z. In other words, the second housing part 120 is disposed to be opposed to the first housing part 110 so as to be capable of sandwiching the shield terminals WT therebetween. More specifically, the first protruding parts 115 of the first housing part 110 and the second protruding parts 125 of the second housing part 120 both abut on outer peripheries of the shield terminals WT. The first protruding parts 115 and the second protruding parts 125 press the shield terminals WT by locking the first locking part 116 and the second locking part 126, and inserting the bolt 108 into the second fixing part 127 to be screwed into the first fixing part 117. In this manner, the shield terminals WT are electrically connected to the upper shell 30 and the lower shell 40.

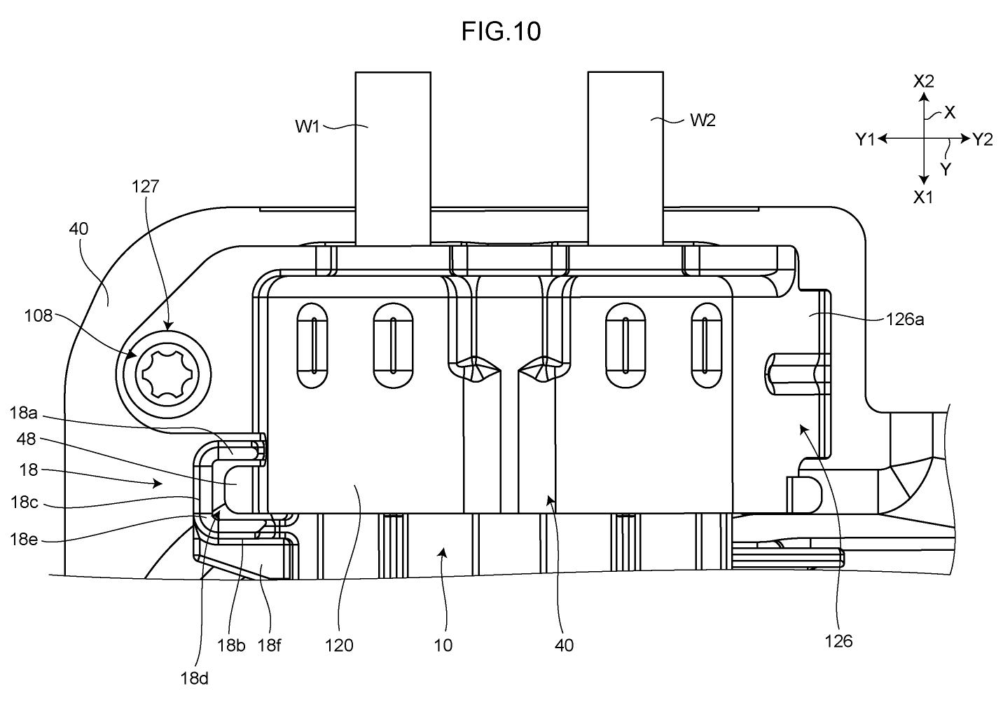

As illustrated in FIG. 10, in a state where the lower shell 40 is attached to the upper shell 30, the rotation regulating projecting part 48 of the lower shell 40 is disposed in an inner region of the opening 18d that is surrounded by the first rotation regulating wall part 18a, the second rotation regulating wall part 18b, and the connection wall 18c.

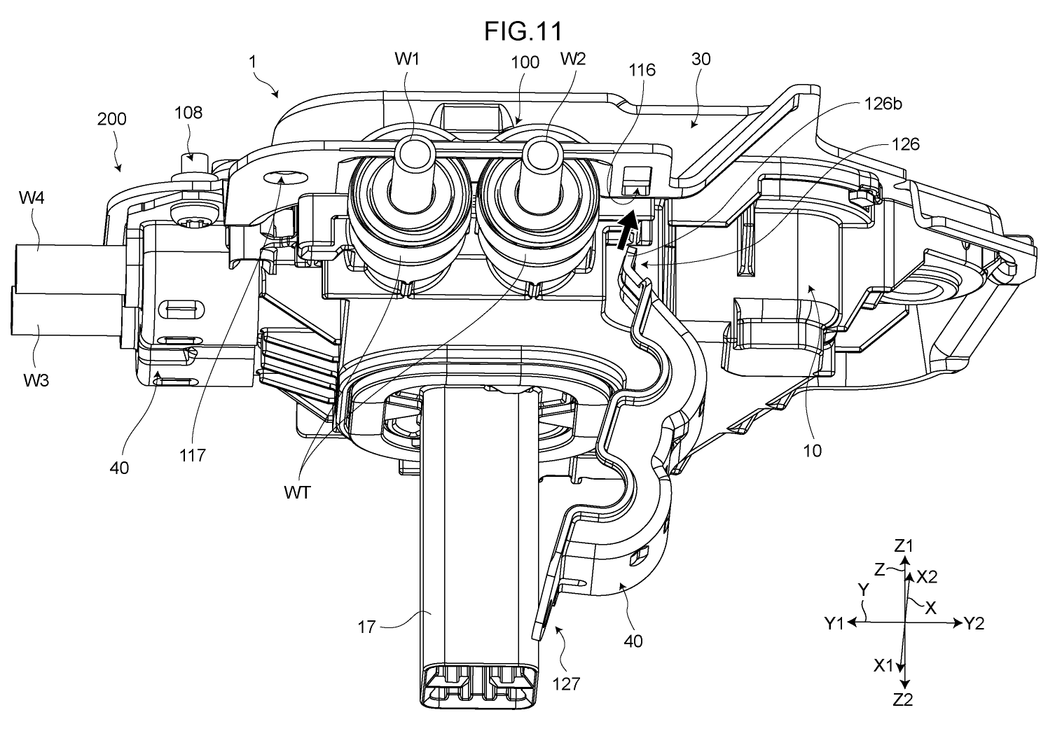

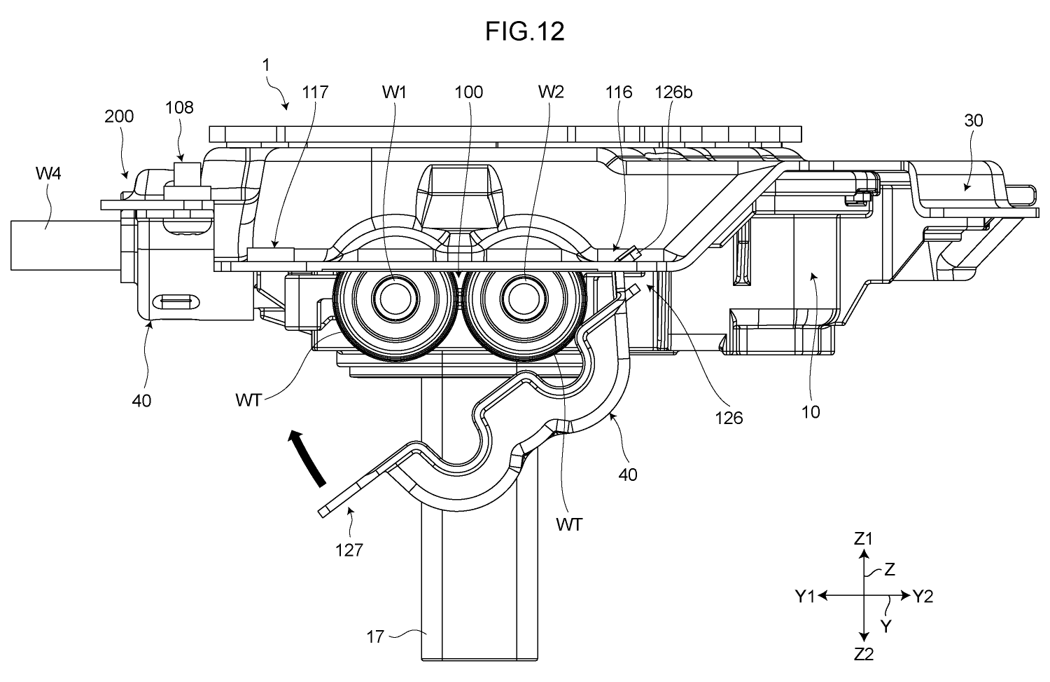

In attaching the lower shell 40 to the upper shell 30, as illustrated in FIG. 11, the second locking part 126 side of the lower shell 40 is directed toward the one side Z1 in the height direction Z, and the claw part 126b of the lower shell 40 is inserted into the slit (first locking part 116). After the claw part 126b of the lower shell 40 is inserted into the slit (first locking part 116) and the claw part 126b is hooked on the opening edge of the slit (first locking part 116) to be locked, as illustrated in FIG. 12, the second fixing part 127 side of the lower shell 40 is moved toward the one side Z1 in the height direction Z. While sandwiching the shield terminals WT between the first housing part 110 and the second housing part 120, the bolt 108 is inserted into the through hole that is the second fixing part 127, and is screwed into the first fixing part 117, which is a female screw part. In this manner, as illustrated in FIG. 1, the lower shell 40 is attached and fixed to the upper shell 30.

When the lower shell 40 is attached to the upper shell 30, the rotation regulating projecting part 48 is inserted into the opening 18d of the rotation regulating wall part 18 from the other side Z2 in the height direction Z. At this time, the rotation regulating projecting part 48 is guided by tapered surfaces 18e of respective tip ends of the first rotation regulating wall part 18a, the second rotation regulating wall part 18b, and the connection wall 18c.

In this manner, the connector 1 holds, by the shielded electric wire holding structures 100 and 200, the shielded electric wires W1, W2, W3, and W4 whose front ends are drawn into the housing 10, and electrically connects the upper shell 30 and the lower shell 40 with the shield terminals WT of the respective shielded electric wires W1, W2, W3, and W4. Accordingly, with the connector 1 incorporated in the wire harness, grounding connection of a shield circuit can be stably performed when the upper shell 30 is connected to a body of a vehicle or the like.

The shielded electric wire holding structure 100 described above includes: the first housing part 110 that is disposed in the upper shell 30 attached to the housing 10, into which the front ends of the shielded electric wires W1 and W2 including the shield material and the shield terminals WT electrically connected to the shield material are drawn, and houses part of the shield terminals WT; the second housing part 120 that is disposed in the lower shell 40 attached to the upper shell 30, houses another part of the shield terminals WT, and is disposed to be opposed to the first housing part 110 so as to be capable of sandwiching the shield terminals WT with the first housing part 110; the first locking part 116 and the first fixing part 117 that are disposed in the upper shell 30 to sandwich the first housing part 110 along the arranging direction Y intersecting the extending direction X of the shielded electric wires W1 and W2; and the second locking part 126 and the second fixing part 127 that are disposed in the lower shell 40 to sandwich the second housing part 120 along the arranging direction Y. The second locking part 126 is locked to the first locking part 116. The first fixing part 117 includes a female screw part that is one of the female screw part into which the bolt 108 is screwed and the through hole through which the bolt 108 is inserted. The second fixing part 127 includes a through hole that is the other one of the female screw part into which the bolt 108 is screwed and the through hole into which the bolt 108 is inserted. The connector 1 includes the housing 10, the upper shell 30, and the lower shell 40.

Accordingly, with a simple configuration of locking the first locking part 116 and the second locking part 126 and fastening one bolt 108, the shielded electric wires W1 and W2 can be reliably sandwiched and held by the first housing part 110 and the second housing part 120. Thus, the shield terminals WT electrically connected to the shield materials of the shielded electric wires W1 and W2 can be stably electrically connected to the upper shell 30 and the lower shell 40 without requiring fastening with a large number of bolts, so that the configuration of holding the shielded electric wires W1 and W2 can be properly implemented. One bolt 108 is used for one shielded electric wire holding structure 100, so that the number of the bolts 108 to be used is small. Accordingly, costs can be reduced, and management costs for components can also be reduced.

The first housing part 110 includes the first protruding parts 115 that protrude toward the second housing part 120 and abut on the shield terminal WT, and the second housing part 120 includes the second protruding parts 125 that protrude toward the first housing part 110 and abut on the shield terminal WT. Due to this, the shield terminals WT, the upper shell 30, and the lower shell 40 are electrically connected more reliably, so that stability of shield circuit connection can be further promoted.

The first locking part 116 includes the slit that is long in the extending direction X, and the second locking part 126 includes the arm part 126a extending from the second housing part 120 and the claw part 126b that is formed by being bent from the arm part 126a. The arm part 126a and the claw part 126b are formed to be insertable into the slit. The claw part 126b includes the abutting part 126b1 that abuts on the outer edge part 33a on the outer side of the slit, and the outer edge part 33a on which the abutting part 126b1 abuts is located on a side opposite to the first housing part 110 with respect to the slit in the arranging direction Y. Due to this, the lower shell 40 can be easily attached to the upper shell 30 by performing an easy operation of hooking the claw part 126b of the second locking part 126 on the first locking part 116, which is the slit.

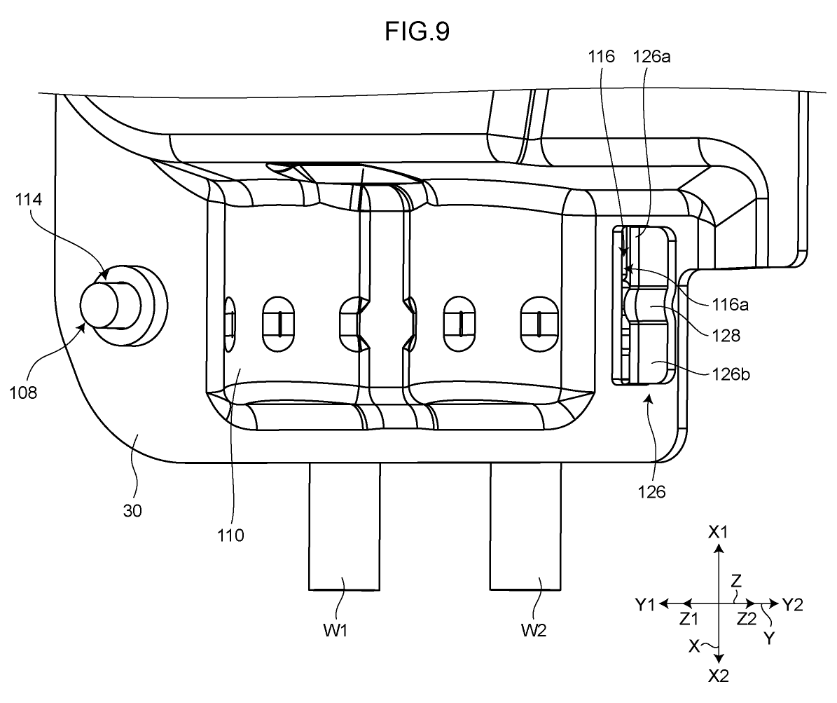

The length L3 along the arranging direction Y of the slit of the first locking part 116 is longer than the length L2 along the arranging direction Y of the abutting part 126b1, and is shorter than the length L1 along the arranging direction Y from the interference part 126a2, which is a portion of the surface on a side of the first housing part 110 of the arm part 126a and is closest to the opening edge 116a of the slit, to the tip end of the abutting part 126b1. Due to this, in a state where the lower shell 40 is attached to the upper shell 30, even when the lower shell 40 is displaced toward the one side Y1 in the arranging direction Y, the interference part 126a2 of the arm part 126a interferes with the opening edge 116a of the slit before the claw part 126b falls off from the first locking part 116 as the slit, so that it is possible to reduce a situation in which the claw part 126b falls off from the slit. Additionally, in attaching the lower shell 40 to the upper shell 30, positioning of the lower shell 40 with respect to the upper shell 30 can also be easily performed. Accordingly, it is also possible to easily perform positioning for making the second fixing part 127, which is the through hole for the bolt 108, and the first fixing part 117, which is the female screw part, coaxial with each other. A width dimension along the extending direction X of the arm part 126a is close to the length along the extending direction X of the slit (refer to FIG. 9), so that the lower shell 40 can be easily positioned also in the extending direction X, and misalignment is reduced.

The second locking part 126 includes the ridge part 128 that is disposed from the tip end of the claw part 126b to the surface 126a1 on a side of the first housing part 110 of the arm part 126a, and the ridge part 128 is formed to be insertable into the slit. Due to this, rigidity of the second locking part 126 having a plate shape can be increased by the ridge part 128, and a gap between the slit and the arm part 126a can be reduced (refer to FIG. 7 to FIG. 9).

The lower shell 40 includes the rotation regulating projecting part 48 that projects in the arranging direction Y on a side of the second fixing part 127, and the housing 10 includes the rotation regulating wall part 18 disposed on the extending direction X side of the rotation regulating projecting part 48. Accordingly, even if the lower shell 40 is likely to rotate about an axis of the bolt 108 due to rotational force caused by fastening of the bolt 108, the rotation regulating projecting part 48, which is likely to move in the extending direction X, immediately interferes with the rotation regulating wall part 18 (specifically, the first rotation regulating wall part 18a), so that misalignment of the lower shell 40 at the time of fastening the bolt 108 can be reduced. Additionally, it is also possible to reduce misalignment of the lower shell 40 caused by a reaction force along the extending direction X from the gaskets WF2 of the shielded electric wires W1 and W2.

The shielded electric wire holding structure and the connector according to the embodiment of the present invention described above are not limited to the embodiment described above, and can be variously modified within the scope of the claims.

In the above description, the first fixing part 117 and the second fixing part 127 are disposed on the one side Y1 in the arranging direction Y, and the first locking part 116 and the second locking part 126 are disposed on the other side Y2, but these may be reversely arranged. Although the first fixing part 117 serves as the female screw part and the second fixing part 127 serves as the through hole, the first fixing part 117 may serve as the through hole and the second fixing part 127 may serve as the female screw part. The first housing part 110 and the second housing part 120 may be formed to hold one shielded electric wire or three or more shielded electric wires. In the present embodiment, the shielded electric wire holding structure 100 is disposed in the connector 1, but it can be also applied to another electric device into which a shielded electric wire is drawn and in which a shield circuit is configured, such as an electric connection box.

The shielded electric wire holding structure and the connector according to the present embodiment may be configured by appropriately combining the constituent elements in the embodiment and modifications described above.

The shielded electric wire holding structure and the connector according to the present embodiment provide an effect that a configuration for holding a shielded electric wire can be properly implemented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A shielded electric wire holding structure comprising:
a first housing part that is disposed in an upper shell attached to a housing, into which a front end of a shielded electric wire including a shield material and a shield terminal electrically connected to the shield material is drawn, and houses part of the shield terminal;
a second housing part that is disposed in a lower shell attached to the upper shell, houses another part of the shield terminal, and is disposed to be opposed to the first housing part so as to be capable of sandwiching the shield terminal with the first housing part;
a first locking part and a first fixing part that are disposed in the upper shell to sandwich the first housing part along an arranging direction intersecting an extending direction of the shielded electric wire; and
a second locking part and a second fixing part that are disposed in the lower shell to sandwich the second housing part along the arranging direction Y, wherein
the second locking part is locked to the first locking part,
the first fixing part includes one of a female screw part into which a bolt is screwed and a through hole into which the bolt is inserted, and
the second fixing part includes the other one of the female screw part into which the bolt is screwed and the through hole into which the bolt is inserted.

2. The shielded electric wire holding structure according to claim 1, wherein
the first housing part includes a first protruding part that protrudes toward the second housing part and abuts on the shield terminal, and
the second housing part includes a second protruding part that protrudes toward the first housing part and abuts on the shield terminal.

3. The shielded electric wire holding structure according to claim 1, wherein
the first locking part includes a slit that is long in the extending direction,
the second locking part includes an arm part extending from the second housing part and a claw part that is formed by being bent from the arm part,
the arm part and the claw part are formed to be insertable into the slit,
the claw part includes an abutting part that abuts on an outer edge part on an outer side of the slit, and
the outer edge part on which the abutting part abuts is located on a side opposite to the first housing part with respect to the slit in the arranging direction.

4. The shielded electric wire holding structure according to claim 3, wherein a length along the arranging direction of the slit is longer than a length along the arranging direction of the abutting part, and is shorter than a length along the arranging direction from an interference part, which is a portion of a surface on a side of the first housing part of the arm part and is closest to an opening edge of the slit, to a tip end of the abutting part.

5. The shielded electric wire holding structure according to claim 3, wherein
the second locking part includes a ridge part that is disposed from a tip end of the claw part to a surface on a side of the first housing part of the arm part, and
the ridge part is formed to be insertable into the slit.

6. The shielded electric wire holding structure according to claim 4, wherein
the second locking part includes a ridge part that is disposed from a tip end of the claw part to a surface on a side of the first housing part of the arm part, and
the ridge part is formed to be insertable into the slit.

7. The shielded electric wire holding structure according to claim 1, wherein
the lower shell includes a rotation regulating projecting part that projects in the arranging direction on a side of the second fixing part, and
the housing includes a rotation regulating wall part disposed on the extending direction side of the rotation regulating projecting part.

8. A connector comprising:
a housing into which a front end of a shielded electric wire including a shield material and a shield terminal electrically connected to the shield material is drawn;
an upper shell that is attached to the housing and includes a first housing part that houses part of the shield terminal; and
a lower shell that is attached to the upper shell and includes a second housing part that houses another part of the shield terminal and is disposed to be opposed to the first housing part so as to be capable of sandwiching the shield terminal with the first housing part, wherein
the upper shell includes a first locking part and a first fixing part that are disposed to sandwich the first housing part along an arranging direction intersecting an extending direction of the shielded electric wire,
the lower shell includes a second locking part and a second fixing part that are disposed to sandwich the second housing part along the arranging direction,
the second locking part is locked to the first locking part,
the first fixing part includes one of a female screw part into which a bolt is screwed and a through hole into which the bolt is inserted, and
the second fixing part includes the other one of the female screw part into which the bolt is screwed and the through hole into which the bolt is inserted.
